(19) United States
(12) Patent Application Publication
(10) Pub. No.: US 2012/0244284 A1
(43) Pub. Date: Sep. 27, 2012

(54) PATTERN FORMING APPARATUS AND PATTERN FORMING METHOD

(75) Inventors: Masakazu SANADA, Kyoto (JP); Masanobu IWASHIMA, Kyoto (JP); Koji FURUICHI, Kyoto (JP)

(73) Assignee: DAINIPPON SCREEN MFG. CO., LTD.

(21) Appl. No.: 13/313,469

(22) Filed: Dec. 7, 2011

(30) Foreign Application Priority Data
Mar. 25, 2011 (JP) 2011-067040

(51) Int. Cl. B05D 5/00; B05C 11/11; B05B 1/00

(52) U.S. Cl. 427/256; 118/313

(57) ABSTRACT

A pattern forming apparatus includes a first nozzle part 52 in which discharge nozzles 523 for discharging an application liquid are arranged in a row in a direction (Y-direction) perpendicular to a scan-moving direction relative to a substrate, and a second nozzle part 72 including a pair of discharge nozzles 723, the positions of which in the Y-direction can be changed by a ball screw mechanism 740. A plurality of pattern elements parallel to each other and having the same length are formed by the discharge of the application liquid from the first nozzle part 52 and, on the other hand, pattern elements having lengths different from these pattern elements are formed by the second nozzle part 72, the application of which is controlled at timings independent of the first nozzle part 52.

### CROSS REFERENCE TO RELATED APPLICATION

The disclosure of Japanese Patent Application No. 2011-067040 filed on Mar. 25, 2011 including specification, drawings and claims is incorporated herein by reference in its entirety.

### BACKGROUND OF THE INVENTION

1. Field of the Invention

This invention relates to a pattern forming technology for forming predetermined pattern elements by applying an application liquid to a substrate surface.

2. Description of the Related Art

There is known a technology for forming a predetermined pattern on a substrate by applying an application liquid containing a material for forming pattern elements to the substrate and curing it. For example, a technology disclosed in JP2010-278225A previously disclosed by the present applicant is applicable to a technology for manufacturing a photoelectric conversion device by forming wiring pattern elements on a substrate having a photoelectric conversion surface. In this technology, a multitude of stripe-shaped pattern elements parallel to each other and having an equal length are formed on a substrate by scan-moving a nozzle with a multitude of discharge ports relative to the substrate and discharging an application liquid containing a pattern forming material from the respective discharge ports.

Substrates for which pattern elements are to be formed by this type of pattern forming technology come in various shapes. For example, some of monocrystalline silicon substrates used as substrates of solar cells have an octagonal shape obtained as if by cutting off four corners of a square. This is for effectively utilizing the areas of circular monocrystalline silicon wafers. The lengths of pattern elements to be formed on such substrates are not necessarily constant.

However, the lengths of all the pattern elements formed by the above technology are same. A technology for efficiently forming pattern elements on a substrate having a non-rectangular shape (hereinafter, referred to as an “irregularly shaped substrate”) by application has not been established yet thus far.

### SUMMARY OF THE INVENTION

This invention was developed in view of the above problem and an object thereof is to provide a technology capable of efficiently forming pattern elements on an irregularly shaped substrate in a pattern forming technology for forming predetermined pattern elements by applying an application liquid to a substrate.

A pattern forming apparatus of the present invention comprises: a substrate holder that holds a substrate; a first nozzle part in which a plurality of first discharge ports for respectively discharging an application liquid containing a material for forming pattern elements are arranged in a row; a second nozzle part that includes a second discharge port for discharging the application liquid; and a mover that moves the first nozzle part relative to the substrate in a scan-moving direction perpendicular to an arrangement direction of the first discharge ports and moves the second nozzle part relative to the substrate in the scan-moving direction such that the second discharge port passes at an outer side of the respective first discharge ports in the arrangement direction, wherein the first discharge ports and the second discharge port discharge the application liquid at different timings.

According to the thus constructed invention, the plurality of linear pattern elements parallel to each other and having an equal length can be formed at one time by a scan-movement of the first nozzle part similar to those disclosed in the above patent literature. Further, the pattern element parallel to the respective pattern elements formed by the first nozzle part and having a length different from these pattern elements can be formed by a scan-movement of the second nozzle part and the discharge of the application liquid at a discharge timing different from the first nozzle part. By combining the application by the first nozzle part and that by the second nozzle part, pattern elements can be efficiently formed also on an irregularly shaped substrate having a non-rectangular shape.

A pattern forming method of the present invention is a method for forming pattern elements by applying an application liquid containing a material for forming the pattern elements to a substrate and comprises: a step of moving a first nozzle part, in which a plurality of first discharge ports for respectively discharging the application liquid are arranged in a row, relative to the substrate in a scan-moving direction perpendicular to an arrangement direction of the first discharge ports, thereby forming a plurality of linear pattern elements corresponding to the plurality of first discharge ports; and a step of moving the second nozzle part including a second discharge port for discharging the application liquid relative to the substrate in the scan-moving direction such that the second discharge port passes at an outer side of the respective first discharge ports in the arrangement direction, thereby forming a linear pattern element, wherein the application liquid being discharged at different timings from the first discharge ports and from the second discharge port.

In the thus constructed invention, pattern elements can be efficiently formed also on an irregularly shaped substrate having a non-rectangular shape similar to the invention relating to the pattern forming apparatus described above. Note that, in this invention, there is no limitation as to which of formation of the pattern elements by the first nozzle part and that of the pattern elements by the second nozzle part is performed first. That is, it does not matter whichever is performed first. Further, formation of the pattern elements may be, for example, either started or ended at the same timing by the first and second nozzle parts.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTIONS OF THE DRAWINGS

FIG. 1 is a drawing which shows a pattern forming apparatus according to a first embodiment of the invention;

FIG. 2 is a diagram which shows structures of the first and second nozzle parts;

FIG. 3 is a diagram which shows an example of a solar cell formed using the pattern forming apparatus of FIG. 1;

FIG. 4 is a flow chart which shows a pattern forming process in this pattern forming apparatus;

FIGS. 5A and 5B are views which diagrammatically show formation of the pattern elements by the first nozzle part;

FIGS. 6A to 6C are diagrams which show the principle of the application ending operation;

FIGS. 7A and 7B are views which diagrammatically show formation of pattern elements by the second nozzle part; and

FIG. 8 is a diagram which shows an outline of a second embodiment of a pattern forming apparatus according to this invention.

### DETAILED DESCRIPTION OF THE PREFERRED EMBODIMENTS

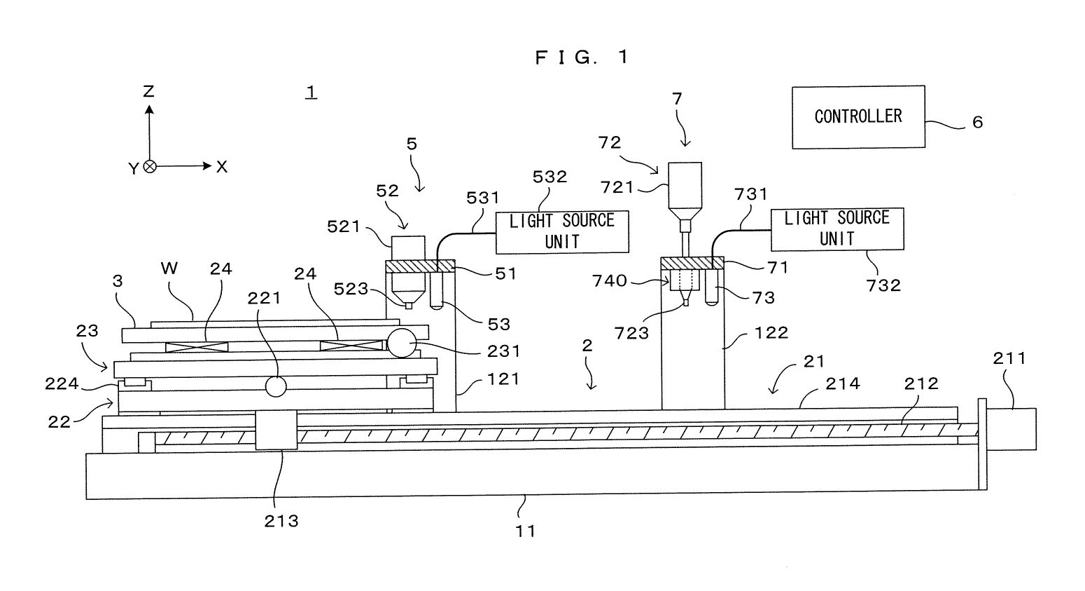

FIG. 1 is a drawing which shows a pattern forming apparatus according to a first embodiment of the invention. The pattern forming apparatus 1 is an apparatus for forming conductive electrode wiring patterns on the substrate W, such as a single-crystalline silicon wafer, which has in its surface a photoelectric conversion layer, and accordingly manufacturing a photoelectric conversion device which will be used as a solar cell for instance. The apparatus 1 may for example be used to form collector electrodes in the incident light-receiving surface of a photoelectric conversion device, as a preferable application.

In the pattern forming apparatus 1, a stage moving mechanism 2 is provided on a stand 11 so that the stage moving mechanism 2 can move a stage 3 which holds the substrate W within the X-Y plane which is shown in FIG. 1. Two frames 121 and 122 are mounted to the stand 11, straddling the stage 3. A first head part 5 is attached to the frame 121, and a second head part 7 is attached to the frame 122. The second head part 7 is away from the first head part 5 in the direction (+X), and the distance between the first head part 5 and the second head part 7 is set such that a distance between a first nozzle part and a second nozzle part described later is wider than the length of the substrate W measured in the X-direction.

The stage moving mechanism 2 comprises an X-direction moving mechanism 21 for moving the stage 3 in the X-direction, a Y-direction moving mechanism 22 for moving the stage 3 in the Y-direction, and a 0 rotation mechanism 23 for rotating the stage 3 about an axis which is directed to the Z-direction. The X-direction moving mechanism 21 has a structure that a ball screw 212 is linked to a motor 211 while a nut 213 fixed to the Y-direction moving mechanism 22 is attached to the ball screw 212. A guide rail 214 is fixed above the ball screw 212. As the motor 211 rotates, the Y-direction moving mechanism 22 smoothly moves together with the nut 213 in the X-direction along the guide rail 214.

The Y-direction moving mechanism 22, too, comprises a ball screw mechanism and a guide rail 224 so that as a motor 221 rotates, the ball screw mechanism makes the θ rotation mechanism 23 move in the Y-direction along the guide rail 224. A motor 231 disposed to the θ rotation mechanism 23 rotates the stage 3 about the axis which is directed toward the Z-direction. The structure described above makes it possible to change the direction of relative movement of the first head part 5 and the second head part 7 to the substrate W and the directions of the first head part 5 and the second head part 7 to the substrate W. A controller 6 controls the respective motors of the stage moving mechanism 2.

A stage elevating/lowering mechanism 24 is disposed between the 0 rotation mechanism 23 and the stage 3. In response to a control command from the controller 6, the stage elevating/lowering mechanism 24 moves the stage 3 up or down, whereby the substrate W is positioned at a designated height (which is a position in the Z-direction). The stage elevating/lowering mechanism 24 may be an actuator such as a solenoid and a piezo-electric element, a gear, combined wedges, etc.

In a base 51 of the first head part 5, a discharge nozzle part 52 which stores a liquid-state (or paste-like) application liquid inside and discharges the application liquid onto the substrate W and a light irradiation part 53 for irradiating UV light (ultraviolet light) toward the substrate W are disposed. More specific description about the first nozzle part 52 is described later.

The light irradiation part 53 is connected to a light source unit 532 which generates UV light through an optical fiber 531. Although not shown, the light source unit 532 comprises at its light emitting part a shutter which can be opened and closed, and in accordance with whether the shutter is open or closed and to which degree the shutter is opened, the light source unit can control on/off and the amount of emitted light. The controller 6 controls the light source unit 532.

A base 71, a discharge nozzle part 72 and a light irradiation part 73 are disposed to the second head part 7 similarly with the first head part 5. The light irradiation part 73 is connected to an optical fiber 731 and a light source unit 732. Functions of the light irradiation part 73, the optical fiber 731 and the light source unit 732 are basically same as those in the first head part 5.

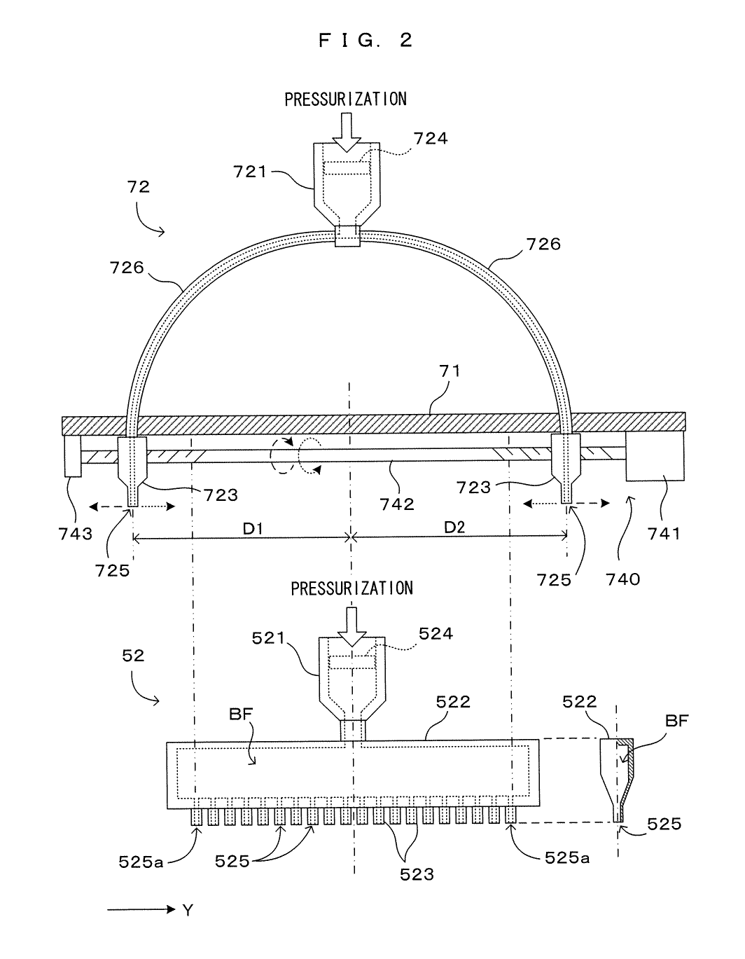

FIG. 2 is a diagram which shows structures of the first and second nozzle parts. As shown in a lower part of FIG. 2, the first nozzle part 52 provided in the first head part 5 includes a syringe pump 521 with an inner hollow for storing the application liquid, a manifold part 522 internally provided with a buffer space BF communicating with the hollow, and a plurality of discharge nozzles 523 arranged in a row in the Y-direction on the lower surface of the manifold part 522. A discharge port 525 communicating with the buffer space BF is provided at the lower end of each discharge nozzle 523. Further, a plunger 524 is inserted in the inner space of the syringe pump 521 and vertically driven by the motor driven and controlled by the controller 6, an actuator such as a solenoid, compressed air or the like.

In such a construction, the plunger 524 is pushed down in response to a control command from the controller 6, whereby the application liquid in the syringe pump 521 is pressurized to be pushed out to the manifold part 522. The application liquid fed to the manifold part 522 is continuously discharged from the discharge ports 525 of the respective discharge nozzles 523 via the buffer space BF. That is, this pattern forming apparatus 1 is a coater adopting a nozzle dispense method. The amounts of the application liquid discharged from the respective discharge ports 525 can be made uniform by discharging the pressure-fed application liquid via the buffer space BF.

On the other hand, as shown in an upper part of FIG. 2, the inner space of a syringe pump 721 for storing the application liquid communicates with discharge ports 725 provided at the lower ends of a pair of discharge nozzles 723, 723 via a pair of flexible hollow tubes 726, 726 in the second nozzle part 72. The respective discharge nozzles 723 are supported movably in a predetermined range in the Y-direction by a ball screw mechanism 740 attached to the base 71. More specifically, the ball screw mechanism 740 includes a motor 741, a ball screw 742 coupled to the motor 741 and extending in the Y-direction and a bearing 743 for supporting an end of the ball screw 742 opposite to the one near the motor 741. Screw grooves of the ball screw 742 are formed in opposite directions at the opposite ends, and nuts threadably engaged with these screw grooves are united with the discharge nozzles 723.

Thus, when the motor 741 rotates in response to a control command from the controller 6, the ball screw 742 rotates and, accordingly, the discharge nozzles 723 move in the Y-direction. Since the directions of the screw grooves threadably engaged with the nuts provided in the two discharge nozzles 723 are opposite, the two discharge nozzles 723 move in directions opposite to each other. Specifically, for example, when the ball screw 742 rotates in a direction indicated by a broken line arrow in FIG. 2, the two discharge nozzles 723 respectively move in directions also indicated by broken line arrows, i.e. away from each other in the Y-direction. Conversely, when the ball screw 742 rotates in a direction indicated by a dotted line arrow in FIG. 2, the two discharge nozzles 723 respectively move in directions also indicated by dotted line arrows, i.e. toward each other in the Y-direction. The two discharge nozzles 723 may be respectively independently driven by separate driving mechanisms.

The discharge ports 725 of the two discharge nozzles 723 are located symmetrically with respect to a center axis (dashed-dotted line) of the row of the discharge ports 525 of the first nozzle part 52 in the Y-direction. That is, Y-direction distances D1, D2 from the center axis to the respective discharge ports 725 are equal. Note that the two discharge ports 725 are located at the same positions in the X-direction and the Z-direction. Further, movable ranges of the discharge ports 725 by movements of the discharge nozzles 723 include outer sides of the outermost discharge ports 525a located on the most outer sides in the row of the discharge ports 525 of the first nozzle part 52.

The syringe pump 721 stores the application liquid in its inner space and a plunger 724 is provided in this inner space. When the plunger 724 is pushed down in response to a control command from the controller 6, the application liquid stored in the syringe pump 721 is pressurized and pushed out from the discharge ports 725 at the lower ends of the discharge nozzles 723 via tubes 726. The application liquid can be equally discharged from the respective discharge ports 725 by pressure-feeding the application liquid from the single syringe pump 721 to the pair of discharge nozzles 723.

The application liquids may be a conductive pastes, or conductive and photo-curing paste-like mixed liquids containing conductive particles, an organic vehicle (namely, a mixture of a solvent, a resin, a thickener, etc.) and a photo-polymerization initiator for instance. The conductive particles may for example be silver powder which is a material to make electrodes, and the organic vehicle contains ethyl cellulose, which serves as a resin material, and an organic solvent. The viscosity of the application liquids is preferably 50 Pa·s (Pascal seconds) or below for instance before execution of hardening under irradiated light but preferably 350 Pa·s or above after execution of hardening under irradiated light. The compositions of the application liquids stored in the first and second nozzle parts 52 and 72 may be the same, or alternatively, the application liquids having different compositions from each other may be stored in the respective nozzle parts.

By constructing the first nozzle part 52 and the second nozzle part 72 as described above, the following effects can be achieved in this embodiment. First, since the first nozzle part 52 includes the plurality of discharge ports 525 arranged in a row in the Y-direction, the application liquid can be applied in stripes extending in the X-direction, parallel to each other and having an equal length by moving the first nozzle part 52 in the X-direction relative to the substrate W while discharging the application liquid from the discharge ports 525. By containing the photo-curing material in the application liquid and irradiating light (e.g. UV light) from the light irradiation part 53 to the application liquid immediately after application, stripe-shaped pattern elements can be formed by curing the application liquid immediately after application while maintaining its cross-sectional shape.

Also in the second nozzle part 72 separate from the first nozzle part 52, stripe-shaped (linear) pattern elements extending in the X-direction can be formed by moving the second nozzle part 72 in the Y-direction relative to the substrate W and irradiating light from the light irradiation part 73 while similarly discharging the application liquid from the discharge ports 725. At this time, since application by the second nozzle part 72, more specifically on/off timings of the discharge of the application liquid can be controlled independently of the first nozzle part 52, pattern elements having lengths different from the pattern elements formed by the first nozzle part 52 and having an equal length can be formed.

In this pattern forming apparatus 1, relative movements of the first and second nozzle parts 52, 72 with respect to the substrate W are realized by moving the substrate W with the first and second nozzle parts 52, 72 fixedly positioned. For a relative movement of a substrate and a nozzle, either one of them may be moved. By fixing the nozzle and moving the substrate, pattern elements can be stably formed by preventing dripping from discharge ports and a variation in discharge amount due to impact or vibration applied to the nozzle.

Further, since the stripe-shaped pattern elements can be formed by the second nozzle part 72 at the outer sides of the row of the discharge ports 525 of the first nozzle part 52 in the Y-direction and at different positions in the Y-direction, the pattern elements can be efficiently formed also on an irregularly shaped substrate having a shape different from a rectangular shape. Particularly, since the pair of discharge ports 725 in the second nozzle part 72 are positioned symmetrically with respect to the center of the row of the discharge ports 525 in the first nozzle part 52, pattern elements can be efficiently formed on a substrate, the shape of which is line-symmetrical with respect to a center line, as described below.

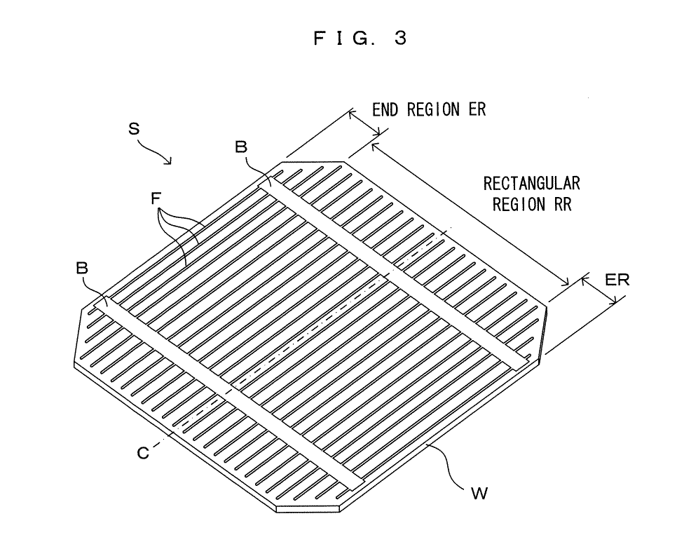

FIG. 3 is a diagram which shows an example of a solar cell formed using the pattern forming apparatus of FIG. 1. This solar cell S is so structured that a multitude of narrow finger wiring pattern elements F and wide bus wiring pattern elements B arranged to cross the finger wiring patterns elements F are provided on a surface (surface with a photoelectric conversion surface and an anti-reflection layer) of the monocrystalline silicone substrate W. The finger wiring pattern elements F and the bus wiring pattern elements B are electrically connected at their intersections.

Concerning dimensions of the respective parts, for example, the width and height of the finger wiring pattern elements F may be set at about 50 μm, the width of the bus wiring pattern elements B may be set at 1.8 mm to 2.0 mm and the height thereof may be set at 50 μm to 70 μm. However, the dimensions are not limited to these numerical values.

The silicon substrate W has an octagonal shape which is formed by cutting off four corners of a substantially square shape and line-symmetrical with respect to a center axis C. This shape results from a disk-shaped wafer cut out from a monocrystalline silicon rod produced to have a substantially cylindrical shape and necessity to form the substrate W effectively utilizing the surface area of the wafer.

Thus, a multitude of finger wiring pattern elements F formed on the substrate W have a fixed length in a seemingly rectangular region RR in a central part of the substrate W, but the finger wiring pattern elements F in each end region ER have lengths different from each other in conformity with the shape of the end region ER. With the conventional technology for forming pattern elements by moving a multitude of nozzles relative to a substrate, the substrate having such a shape could not be coped with. Contrary to this, since application is individually controlled in the rectangular region RR and the end regions ER in the pattern forming apparatus 1 of this embodiment, pattern elements can be efficiently formed also on an irregularly shaped substrate as shown in FIG. 3.

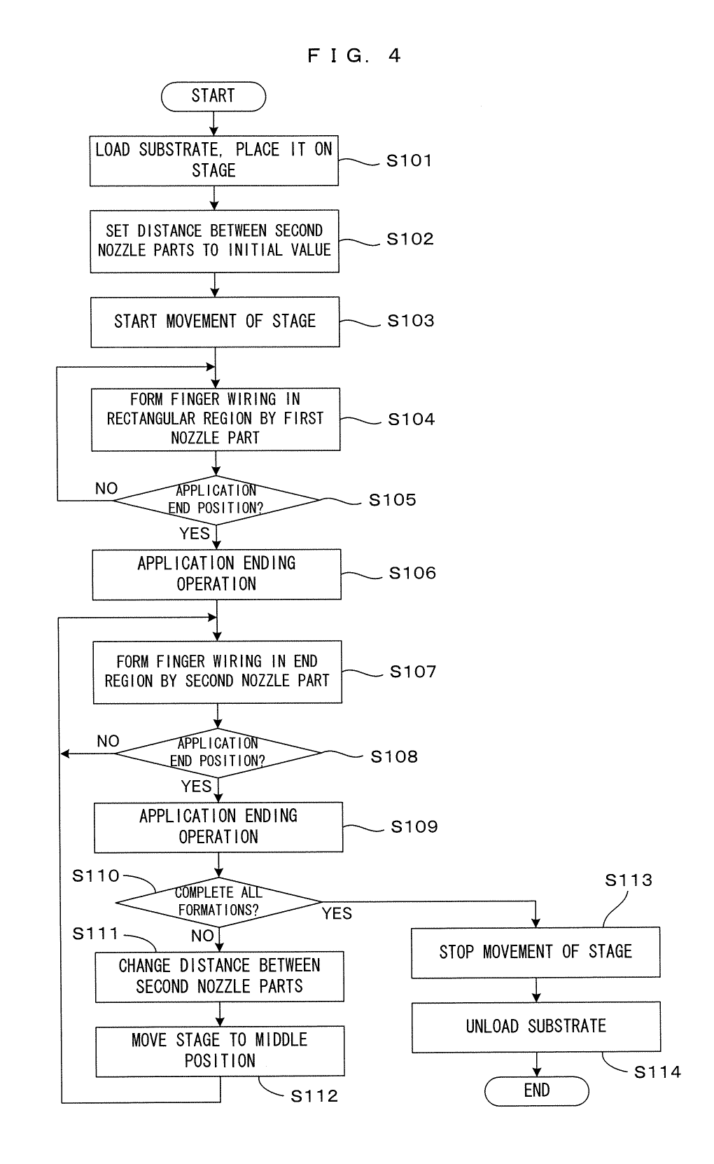

FIG. 4 is a flow chart which shows a pattern forming process in this pattern forming apparatus. More specifically, the pattern forming process of FIG. 4 is a process for forming the finger wiring pattern elements F on the octagonal substrate W as shown in FIG. 3. First, the substrate W is loaded into the pattern forming apparatus 1 and placed on the stage 3 (Step S101). Subsequently, the ball screw mechanism 740 is actuated to set a distance between the two discharge nozzles 725 in the second nozzle part 72 to a predetermined initial value (Step S102). This will be described in detail later. In this state, the stage 3 is started moving in the X-direction (Step S103), and the discharge of the application liquid from the discharge nozzles 523 of the first nozzle part 52 is started to form the finger wiring pattern elements in the rectangular region RR (Step S104). Note that the movement of the substrate W and the discharge of the application liquid are preferably substantially simultaneously started to make the starting ends of the pattern elements have a uniform cross-sectional shape.

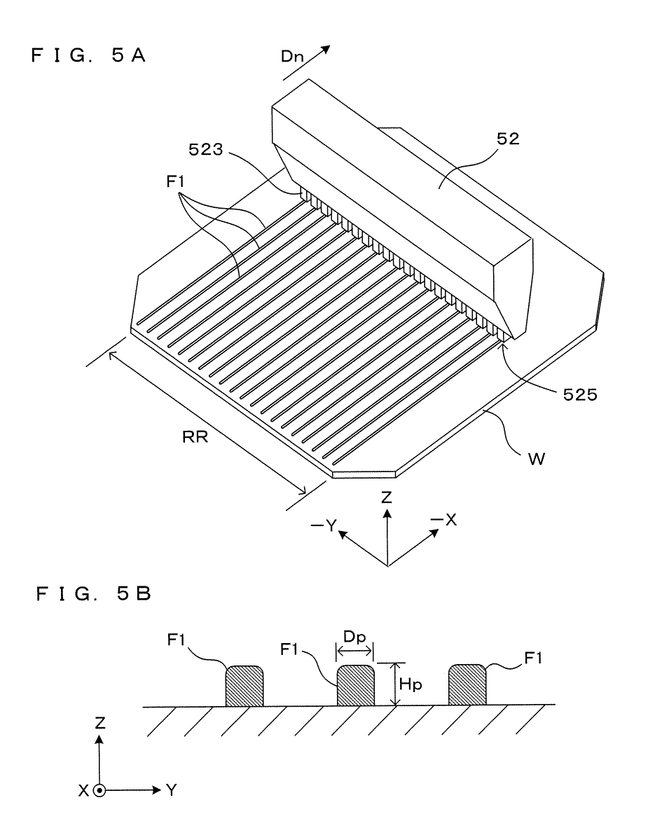

FIGS. 5A and 5B are views which diagrammatically show formation of the pattern elements by the first nozzle part. As shown in FIG. 5A, a plurality of discharge nozzles 523 of the first nozzle part 52 are arranged at equal intervals in a range corresponding to the width of the rectangular region RR of the substrate W and a plurality of stripe-shaped (linear) finger wiring pattern elements F1 extending in a scan-moving direction Dn, parallel to each other and having an equal length can be simultaneously formed by moving the first nozzle part 52 relative to the substrate W in the scan-moving direction Dn (−X-direction) while discharging the application liquid from the respective discharge nozzles 523.

Although not shown in FIG. 5A, the light irradiation part 53 moving relative to the substrate W to follow the first nozzle part 52 moving relative to the substrate W irradiates the application liquid with light in this embodiment as shown in FIG. 1. Thus, the application liquid immediately after being discharged from the discharge ports 525 is successively irradiated to be cured, whereby the finger wiring pattern elements F1 maintaining a cross-sectional shape immediately after the discharge are formed. When the discharge ports 525 have a rectangular opening, pattern elements having a substantially rectangular cross-sectional shape can be formed as shown in FIG. 5B. Therefore, a wiring pattern element with a high ratio of height Hp to width Dp of the pattern elements, i.e. a high aspect ratio can be efficiently formed.

Referring back to FIG. 4, the pattern forming process is further described. The relative movement of the first nozzle part 52 with respect to the substrate W as described above is continued until the first nozzle part 52 reaches a predetermined application end position (e.g. end of the substrate) (Step S105). When the application end position is reached, an application ending operation is performed (Step S106). The application ending operation includes the stop of discharge of the application liquid from the respective discharge ports 525, the stop of movement of the stage 3 in the X-direction and a lowering movement of the stage 3 by the stage elevating/lowering mechanism 24.

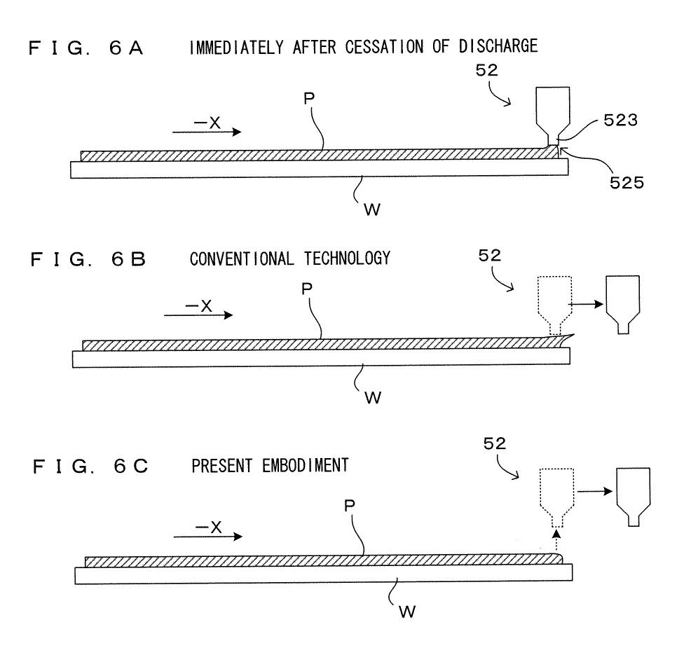

FIGS. 6A to 6C are diagrams which show the principle of the application ending operation. Upon ending the discharge when the first nozzle part 52 scan-moving along the surface of the substrate W reaches the application end position (substrate right end), application liquid P applied on the substrate W is continuous with the application liquid around the discharge ports 525 or in the nozzles due to its surface tension as shown in FIG. 6A. If the scan-movement of the first nozzle part 52 is continued in this state, the application liquid is extended by the discharge nozzles 523 to produce thin trails as shown in FIG. 6B or the pattern elements may be formed beyond the application end position on the substrate W where they should end.

In this embodiment, this is prevented by performing the application ending operation including the stop of discharge of the application liquid from the respective discharge ports 525, the stop of movement of the stage 3 and the lowering movement of the stage 3. That is, as shown in FIG. 6C, the movement of the substrate W in the X-direction is stopped when the discharge of the application liquid from the discharge ports 525 is stopped. By further lowering the substrate W together with the stage 3, the first nozzle part 52 is relatively retracted in a direction away from the surface of the substrate W, thereby separating the application liquid P applied on the substrate W and the first nozzle part 52. By linking a scan-movement and a separating movement of the first nozzle part 52 relative to the substrate W in synchronization with a discharge timing of the application liquid from the discharge ports 525 in this way, the shapes of the final ends of the pattern elements can be aligned without disturbing the application liquid on the substrate W.

By the above operations up to Step S106, a multitude of finger wiring pattern elements F1 parallel to each other and having an equal length are formed in the rectangular region RR on the substrate W. Subsequently, pattern elements are formed in the end regions ER using the second nozzle part 72. First, this is outlined.

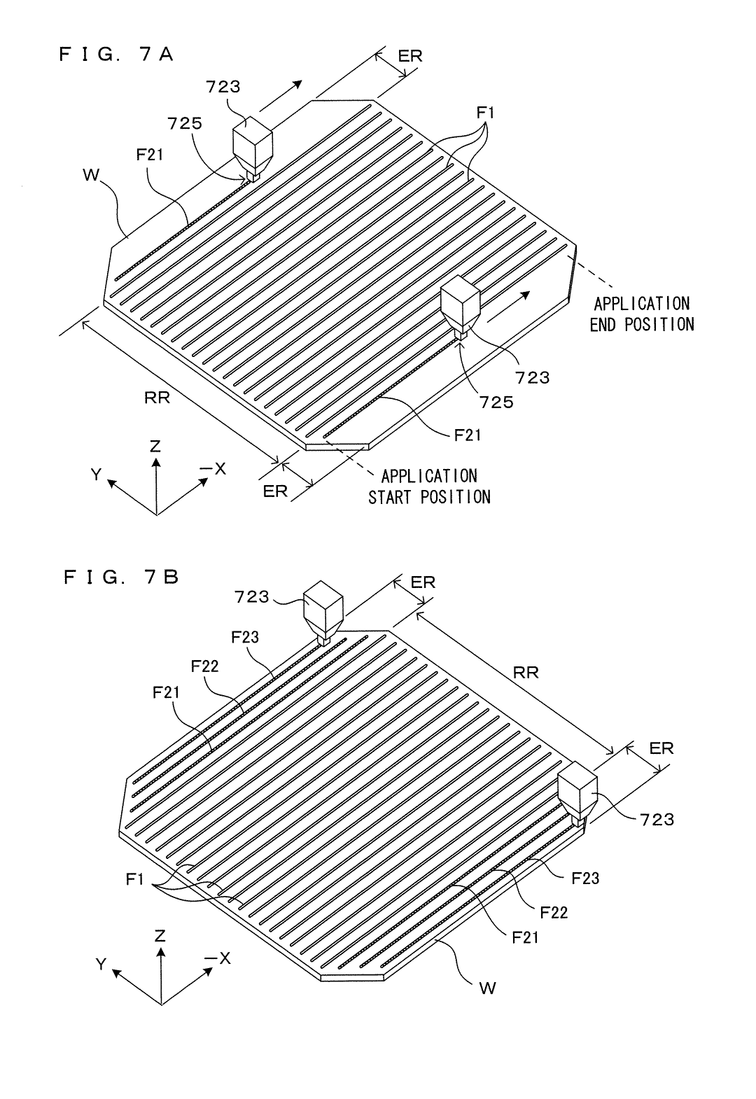

FIGS. 7A and 7B are views which diagrammatically show formation of pattern elements by the second nozzle part. As shown in FIG. 7A, the pattern elements are formed in the end regions ER by discharging the application liquid from the discharge ports 725 while moving the pair of discharge nozzles 723 provided in the second nozzle part 72 relative to the substrate W having the finger wiring pattern elements F1 already formed thereon. At this time, formation positions of the pattern elements in the Y-direction are determined by adjusting the distance between the two discharge nozzles 723 in the Y-direction by the ball screw mechanism 740. Further, the lengths of the pattern elements are adjusted by making a mode of scan-movements of the discharge nozzles 723 relative to the substrate W and the discharge timing of the application liquid from the discharge ports 725 different from those by the first nozzle part 52 to change application start positions and application end positions on the substrate W.

A plurality of pattern elements to be formed in the end regions ER are formed by scan-moving the two discharge nozzles 723 relative to the substrate W a plurality of times while changing the positions of the discharge nozzles 723 in the Y-direction by the ball screw mechanism 740. That is, as shown in FIG. 7A, the positions of the discharge nozzles 723 are so set that these nozzles pass right at the outer sides of the outermost ones of the already formed wiring pattern elements F1 in the row, thereby first forming a pair of pattern elements F21. A distance between the two nozzles 723 at this time is equivalent to the “initial value” in Step S102 of FIG. 4.

Subsequently, pattern elements F22, F23, . . . are successively formed as shown in FIG. 7B by repeating scan-movements of the discharge nozzles 723 relative to the substrate W each time while changing the distance between the discharge nozzles 723 little by little. At this time, the start end position, final end position and length of the pattern elements formed by each scan-movement can be changed by changing the application start position and application end position according to a set value of the nozzle spacing. In this way, wiring pattern elements corresponding to the shapes of the end regions ER can be formed. Further, symmetric pattern elements can be formed by maintaining the two discharge nozzles 723 at positions symmetrical with respect to the center line of the substrate W.

This operation procedure is described with reference to the flow chart of FIG. 4. By the process up to Step S106, the finger wiring pattern elements F1 (FIG. 5A) are formed on the substrate W and the stage 3 carrying the substrate W is located at a middle position between a position right below the first nozzle part 52 and a position right below the second nozzle part 72. In following Step S107, a pair of finger wiring pattern elements (e.g. pattern elements F21) are formed in the end regions ER as described above by passing the stage 3 carrying the substrate W below the second nozzle part 72 while discharging the application liquid from the discharge ports 725 of the pair of discharge nozzles 723 provided in the second nozzle part 72. When the positions of the discharge nozzles 723 relative to the substrate W reach the application end position (Step S108), the application ending operation is performed to align the final ends of the pattern elements as in the case of application by the first nozzle part (Step S109).

Then, whether or not formation of all the necessary pattern elements has been completed is determined (Step S110), the distance between the two discharge nozzles 723 provided in the second nozzle part 72 is changed and set (Step S111) and the stage 3 is returned to the middle position (Step S112) if there are pattern elements yet to be formed. In this state, the discharge nozzles 723 are scan-moved relative to the substrate W to form new pattern elements (e.g. pattern elements F22). As described above, the positions and shapes of the start ends and final ends of the pattern elements are aligned by synchronizing the timing of the scan-movements of the discharge nozzles 723 relative to the substrate W and the discharge timings from the discharge ports 725 every time each two pattern elements are formed.

When this is repeated a necessary number of times and it is determined that all the necessary pattern elements have been formed (Step S110), the stage 3 is moved to a predetermined substrate unloading position and then the movement thereof is stopped (Step S113) and the substrate W having all the finger wiring pattern elements F formed thereon is unloaded (Step S114), thereby completing the pattern forming process.

The bus wiring pattern elements B are subsequently formed on the substrate W having the finger wiring pattern elements F formed thereon in this way and the solar cell S shown in FIG. 3 can be completed by performing a heating (fire-through) process if necessary. Formation of the bus wiring pattern elements and the heating process are not particularly limited and not described here since known technologies can be applied.

As described above, in this embodiment, the finger wiring pattern elements are formed on the octagonal monocrystalline silicon substrate. At this time, the finger wiring pattern elements F1 parallel to each other and having an equal length are formed in the rectangular region RR in the central part of the substrate by scan-moving the first nozzle part 52, in which the multitude of discharge ports 525 are arranged in a row, relative to the substrate W. On the other hand, for the end regions ER of the substrate in which the lengths of the pattern elements to be formed are not fixed, the second nozzle part 72 including the pair of discharge nozzles 723, the positions of which in the Y-direction perpendicular to the scan-moving direction (X-direction) can be changed and set, is scan-moved relative to the substrate W. By independently performing formation of the pattern elements in the rectangular region RR and that of the pattern elements in the end regions ER in this way, desired pattern elements can be efficiently formed on an irregularly shaped substrate having a non-rectangular shape as in this example.

Further, the shapes of the start ends and final ends of the pattern elements can be aligned by synchronizing the start and end timings of the scan-movements of the discharge nozzles relative to the substrate W and the discharge timings of the application liquid from the discharge ports. In this case, application by the second nozzle part 72 is performed independently of application by the first nozzle part 52. Thus, in this embodiment, scan-movements and discharges can be performed at optimal timings for pattern elements having different lengths and such pattern elements having different lengths can be formed with good controllability.

Further, a plurality of pattern elements are formed in the end regions ER by making the distance between the two discharge nozzles 723 of the second nozzle part 72 changeable and repeating the scan-movement while changing this distance. Thus, the second nozzle part 72 only has to include the pair of discharge nozzles 723 regardless of the number of pattern elements to be formed in the end regions ER. Therefore, the apparatus construction is simplified.

As described above, in this embodiment, the stage 3 functions as a “substrate holder” of the present invention. Further, the discharge ports 525 provided in the first nozzle part 52 correspond to “first discharge ports” of the present invention, whereas the discharge ports 725 provided in the second nozzle part 72 correspond to a “second discharge port” of the present invention. Further, the syringe pump 521 and the manifold part 522 in the first nozzle part 52 and the syringe pump 721 in the second nozzle part 72 respectively function as an “application liquid storage” of the present invention. The stage moving mechanism 2 and the ball screw mechanism 740 function as a “mover” of the present invention.

The invention is not limited to the embodiments described above but may be modified in various manners in addition to the embodiments above, to the extent not deviating from the object of the invention. For example, in the above embodiment, the finger wiring pattern elements having different lengths are formed in the end regions ER by changing the distance between the two discharge nozzles 723 of the second nozzle part 72 and performing a scan-movement relative to the substrate each time. Instead of this, the following arrangement may be, for example, employed.

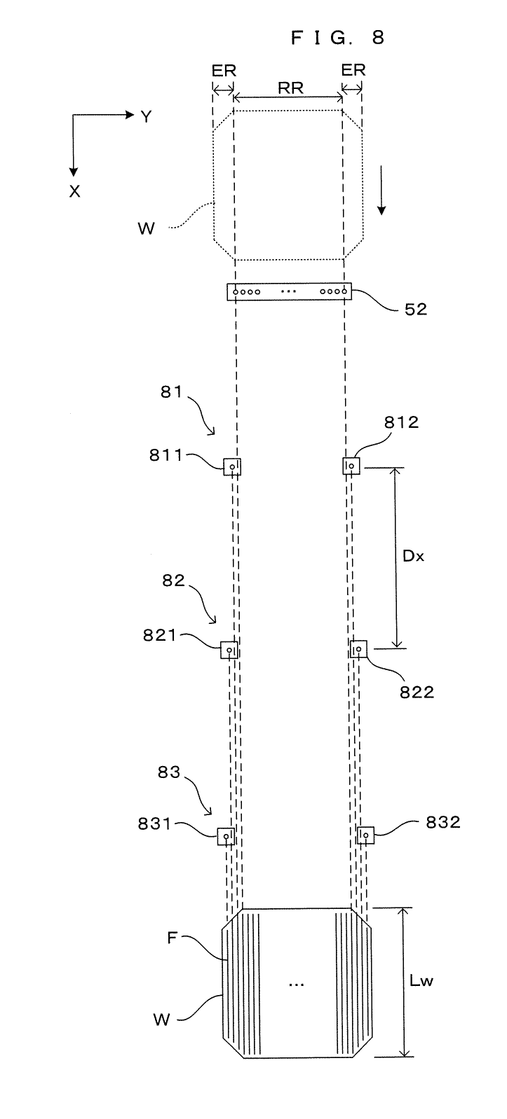

FIG. 8 is a diagram which shows an outline of a second embodiment of a pattern forming apparatus according to this invention. In this embodiment, a first nozzle part 52, a plurality of second nozzle parts 81, 82, 83, . . . , in which distances between paired discharge nozzles (811 and 812, 821 and 822, 831 and 832) in a Y-direction differ from each other are successively arranged in a moving direction (X-direction) of a substrate W by a movement of a stage.

In such a construction, the discharge nozzles 811, 812, . . . , are arranged beforehand at positions corresponding to positions of a plurality of respective pattern elements to be formed in end regions ER. Accordingly, nozzle positions need not be changed in the Y-direction and desired pattern elements can be formed by simply causing the substrate W to pass at positions facing the respective nozzle parts. Since this embodiment can improve throughput in successively forming pattern elements on a plurality of substrates, it is more suitable for mass production.

Also in this case, a movement of the substrate and discharge timings are preferably synchronized to align the shapes of the pattern elements. The discharge timings differ when the lengths of the pattern elements differ. Thus, even in the case of successively processing a multitude of substrates, a movement and discharge for each substrate are preferably independently controllable. A distance Dx between the respective nozzle parts in the X-direction is preferably larger than length Lw of the substrate W in the X-direction to process the respective substrates in parallel with an independent control of movements of the respective substrates.

Further, in the above embodiment, the finger wiring pattern elements F1 are first formed in the rectangular region RR of the monocrystalline silicon substrate W, subsequently the finger wiring pattern elements F21 and the like are formed in the end regions ER and then the bus wiring pattern elements B are formed to form the solar cell S. However, the order of these processes is not limited to this. For example, wiring pattern elements may be formed in the rectangular region RR after wiring pattern elements are formed in the end regions ER. Further, either the application start timing or the application end timing may be simultaneous between the pattern elements to be formed in the rectangular region RR and the pattern elements to be formed in the end regions ER. Furthermore, a substrate having the bus wiring pattern elements B already formed thereon may be loaded into the pattern forming apparatus 1 to form the finger wiring pattern elements F.

Although electrodes are obtained by curing the application liquid by irradiating light to the application liquid containing the photo-curing resin in the above embodiments, it is not an essential requirement that the application liquid contains the photo-curing resin and that light is irradiated to the application liquid. Further, whether or not to perform the heating process after application of the application liquid is also optional.

Although the wirings are formed only on one side of the substrate W in the above respective embodiments, the present invention can be applied also in the case of forming wirings on both sides of the substrate W. Further, the shape of the substrate and the number of the pattern elements in the above embodiments are only examples, and an application range of the present invention is not limited to these.

Although the solar cell as the photoelectric conversion device is manufactured by forming the electrode wiring pattern elements on the monocrystalline silicon substrate in the above respective embodiments, the substrate is not limited to a silicon substrate. For example, the present invention can be applied also in forming pattern elements on a thin-film solar cell formed on a glass substrate or a device other than the solar cell.

This invention is applicable to an apparatus and a method for forming pattern elements on a substrate, e.g. electrode wiring pattern elements on a solar cell substrate and can be particularly preferably applied in the case of forming pattern elements having different lengths on an irregularly shaped substrate having a non-rectangular shape.

In this invention, the mover may, for example, move the first nozzle part relative to the substrate in synchronization with the discharge of the application liquid from the first discharge ports and move the second nozzle part relative to the substrate in synchronization with the discharge of the application liquid from the second discharge port. In a transient state such as when the discharge of the application liquid is started and ended, the shapes of the pattern elements might be disturbed since the discharge amount is not stable. This problem can be solved by moving the first and second nozzle parts relative to the substrate in synchronization with the discharge timings.

Further, the second nozzle part may be, for example, change and set a position of the second discharge port in the arrangement direction can be changed and set. In such a construction, a multitude of pattern elements can be formed by scan-moving the second nozzle part each time while changing the position of the second discharge port in the arrangement direction. Particularly, if a relative movement amount of the second nozzle part with respect to the substrate in the scan-moving direction is changed according to the set position of the second discharge port in the arrangement direction, pattern elements having various lengths can be formed by the second nozzle part.

Further, a plurality of the second nozzle parts, the positions of the second discharge ports of which differ from each other in the arrangement direction, may be, for example, arranged. By doing so, a plurality of pattern elements can be efficiently formed by the plurality of second nozzle parts.

Further, a pair of the second discharge ports may be, for example, provided at the opposite sides of the first nozzle part in the arrangement direction. By doing so, pattern elements having different lengths from the pattern elements formed by the first nozzle part can be formed at the opposite sides of the latter pattern elements. Note that the second discharge ports need to be located at the opposite sides of the first nozzle part in the arrangement direction, but a positional relationship between the first nozzle part and the second discharge ports in the scan-moving direction is not limited.

In this case, the pair of second discharge ports may be arranged at positions symmetrical with respect to the row of the first discharge ports, and the mover may integrally move the pair of second discharge ports relative to the substrate. In such a construction, pattern elements can be efficiently formed on a substrate with a shape symmetrical with respect to an axis in the scan-moving direction such as a monocrystalline silicon substrate for solar cell.

Further, the application liquid may be, for example, supplied to the pair of respective second discharge ports from a same application liquid storage for storing the application liquid. By doing so, pattern elements having the same cross-sectional shape and length can be formed under the same condition of discharging the application liquid from the respective second discharge ports. Similarly, the application liquid may also be supplied to the plurality of first discharge ports from a same application liquid storage for storing the application liquid. By doing so, the plurality of pattern elements formed by the first nozzle part can be made to have the same cross-sectional shape and length.

In this invention, positions of the first nozzle part and the second nozzle part in the scan-moving direction may be fixed and the mover may realize relative movements of the first and second nozzle parts with respect to the substrate by moving the substrate holder holding the substrate. In the case of moving the first and second nozzle parts discharging the application liquid, the discharge amount of the application liquid varies and the shapes of the pattern elements may be disturbed due to impact and vibration applied to the nozzle parts. Such a problem is prevented by moving the substrate without moving the first and second nozzle parts.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A pattern forming apparatus, comprising:
a substrate holder that holds a substrate;
a first nozzle part in which a plurality of first discharge ports for respectively discharging an application liquid containing a material for forming pattern elements are arranged in a row;
a second nozzle part that includes a second discharge port for discharging the application liquid; and
a mover that moves the first nozzle part relative to the substrate in a scan-moving direction perpendicular to an arrangement direction of the first discharge ports and moves the second nozzle part relative to the substrate in the scan-moving direction such that the second discharge port passes at an outer side of the respective first discharge ports in the arrangement direction, wherein
the first discharge ports and the second discharge port discharge the application liquid at different timings.

2. The pattern forming apparatus according to claim 1, wherein the mover moves the first nozzle part relative to the substrate in synchronization with the discharge of the application liquid from the first discharge ports and moves the second nozzle part relative to the substrate in synchronization with the discharge of the application liquid from the second discharge port.

3. The pattern forming apparatus according to claim 1, wherein the second nozzle part changes and sets a position of the second discharge port in the arrangement direction.

4. The pattern forming apparatus according to claim 3, wherein the mover can change a relative movement amount of the second nozzle part with respect to the substrate in the scan-moving direction according to the set position of the second discharge port in the arrangement direction.

5. The pattern forming apparatus according to claim 1, comprising a plurality of the second nozzle parts, the positions of the second discharge ports of which differ from each other in the arrangement direction.

6. The pattern forming apparatus according to claim 3, wherein a pair of the second discharge ports are provided at the opposite sides of the first nozzle part in the arrangement direction.

7. The pattern forming apparatus according to claim 6, wherein:
the pair of second discharge ports are arranged at positions symmetrical with respect to the row of the first discharge ports; and
the mover integrally moves the pair of second discharge ports relative to the substrate.

8. The pattern forming apparatus according to claim 6, wherein the application liquid is supplied to the pair of respective second discharge ports from a same application liquid storage for storing the application liquid.

9. The pattern forming apparatus according to claim 1, wherein the application liquid is supplied to the plurality of first discharge ports from a same application liquid storage for storing the application liquid.

10. The pattern forming apparatus according to claim 1, wherein:
positions of the first nozzle part and the second nozzle part in the scan-moving direction are fixed; and
the mover realizes relative movements of the first nozzle part and the second nozzle part with respect to the substrate by moving the substrate holder holding the substrate.

11. A pattern forming method for forming pattern elements by applying an application liquid containing a material for forming the pattern elements to a substrate, comprising:
a step of moving a first nozzle part, in which a plurality of first discharge ports for respectively discharging the application liquid are arranged in a row, relative to the substrate in a scan-moving direction perpendicular to an arrangement direction of the first discharge ports, thereby forming a plurality of linear pattern elements corresponding to the plurality of first discharge ports; and
a step of moving the second nozzle part including a second discharge port for discharging the application liquid relative to the substrate in the scan-moving direction such that the second discharge port passes at an outer side of the respective first discharge ports in the arrangement direction, thereby forming a linear pattern element, wherein
the application liquid being discharged at different timings from the first discharge ports and from the second discharge port.
